(19) United States
(12) Patent Application Publication
(10) Pub. No.: US 2004/0118905 A1
(43) Pub. Date: Jun. 24, 2004

(54) Apparatus and method for discretely and securely sending and receiving messages on post cards

(76) Inventor: Jason M. Luetkenhaus, Omaha, NE (US)

Correspondence Address: LAW OFFICES OF ADAM H. JACOBS, SUITE 726, 1904 FARNAM STREET, OMAHA, NE, 68102, US

(21) Appl. No.: 10/672,826

(22) Filed: Sep. 26, 2003

Related U.S. Application Data
(60) Provisional application No. 60/417,961, filed on Oct. 11, 2002.

(51) Int. Cl. B42D 15/00

(52) U.S. Cl. 229/92.8

(57) ABSTRACT

An apparatus for discretely and securely sending and receiving messages on post cards includes a generally flat planar post card message cover having an inner face and an outer face and including a generally rectangular generally opaque cover plate sized to fit onto and cover one side of a post card. At least one adhesive strip is mounted on the inner face of the post card message cover for securely attaching the post card message cover to the post card in generally parallel contact therewith. A generally opaque message revealing panel section of the post card message cover is operative to removably cover a message printed on the post card, the message revealing panel section being movable between a message covering position releasably connected and aligned generally coplanar with the post card message cover and a message revealing position permitting viewing of a message printed on the post card.

### CROSS-REFERENCE TO RELATED APPLICATION

This application claims priority to the filing date of related provisional patent application serial No. 60/417,961 filed Oct. 11, 2002.

### BACKGROUND OF THE INVENTION

1. Technical Field

The present invention relates to an apparatus for securely mailing post cards through the mail, and more particularly, to a post card message cover which includes a generally rectangular opaque cover plate sized to fit onto and cover one side of a post card and the message written thereon, the post card message cover being securely attached to the post card in generally parallel contact therewith by at least one adhesive strip and a message revealing panel section of the cover plate formed as an interconnected set of perforation lines which are separable along the lines to permit the message revealing panel section to be opened and lifted from the cover plate to reveal the message written on the post card.

2. Description of the Prior Art

Post cards are a common form communication between people today. Typically they are used to send brief personal messages to friends and family while traveling away from home. A problem with post cards, however, is the inability to send messages discretely and securely through the mail. The reason is the sender usually writes their message on one side of the post card and then drops it in the nearest mailbox. Consequently, anyone who then handles that particular post card is capable of reading the confidential and/or personal message written thereon, which is undesirable. Currently, then, users of post cards must then resign themselves to having their message read by any number of people involved in the transport of mail.

Various methods proposed in the prior art include the folding over of portions of the post card to protect the message written thereon and/or including a built-in flap or the like which may be folded over the message once the message is written on the post card to prevent unauthorized viewing of the message written thereon. While each of these prior art devices include some advantages, it is also clear that they include inherent disadvantages which have yet to be addressed and solved. For example, the folding of a post card may result in damage to the post card or render it unacceptable for mailing and the use of various types of covering flaps which are integral to the post card may make the post card more difficult to display, sell, or transport through the mail. There is therefore a need for an easy-to-use method and apparatus which allows a sender of a post card to discretely and securely send the message printed thereon.

Therefore, an object of the present invention is to provide an apparatus and method for discretely and securely sending and receiving messages on post cards.

Another object of the present invention is to provide a post card message cover which includes a generally rectangular opaque cover plate sized to fit on and cover one side of a post card and the message written thereon, the post card message cover being securely attached to the post card in generally parallel contact therewith by at least one adhesive strip.

Another object of the present invention is to provide an apparatus and method for discretely and securely sending and receiving messages on post cards which includes a message-revealing panel section of the cover plate which is separable from the remaining portion of the post card message cover to permit the opening and lifting of the message-revealing panel section from the cover plate to reveal the message written on the post card.

Another object of the present invention is to provide an apparatus and method for discretely and securely sending and receiving messages on post cards which may be quickly and easily applied to various types and sizes of post cards, yet will still provide coverage for the message printed thereon.

Another object of the present invention is to provide an apparatus and method for discretely and securely sending and receiving messages on post cards which may be packaged separately from the post card, yet may be quickly and easily applied thereto.

Finally, an object of the present invention is to provide an apparatus and method for discretely and securely sending and receiving messages on post cards which is relatively simple to manufacture and is safe, efficient, and discreet in use.

### SUMMARY OF THE INVENTION

The present invention provides an apparatus for discretely and securely sending and receiving messages on post cards which includes a generally flat planar post card message cover having an inner face and an outer face and including a generally rectangular generally opaque cover plate sized to fit onto and cover one side of a post card and the message written thereon. At least one adhesive device such as an adhesive strip is mounted on the inner face of the post card message cover for securely attaching the post card message cover to a post card in generally parallel contact therewith with the inner face of the post card message cover adjacent the post card. Finally, the post card message cover further includes a generally opaque message revealing panel section positioned on the post card message cover, the message revealing panel section operative to removably cover a message printed on the post card, the message revealing panel section being movable between a message covering position releasably connected and aligned generally coplanar with the post card message cover and a message revealing position permitting viewing of a message printed on the post card.

It is thus seen that the present invention provides a substantial improvement over those inventions found in the prior art. For example, many of the devices found in the prior art address only the issue of covering the message to prevent unauthorized viewing, but do not address the issues of ease of use and ability of the completed assembly to be mailed for the same cost of mailing the post card by itself. Furthermore, as the present invention is relatively simple and inexpensive in manufacture and is durable in use, the user may purchase the message cover for little money and quickly apply and use the cover of the present invention as opposed to the methods of application required by many of the devices found in the prior art. Finally, because the present invention may be sold separately from the post cards themselves, a purchaser need not choose only those post cards fitted with the privacy-enhancing cover of the present invention, but instead may choose any particular post card and then after writing the message thereon, apply the message cover of the present invention prior to mailing to ensure the security of the message. The present invention thus provides a substantial improvement over the prior art.

### BRIEF DESCRIPTION OF THE DRAWINGS

FIG. 1 is a front elevational view of the present invention showing the features thereof.

FIG. 2 is a rear elevational view of the present invention showing the features on the rear thereof.

FIG. 3 is a perspective view showing the present invention in use as it reveals the message displayed on the post card.

### DESCRIPTION OF THE PREFERRED EMBODIMENT

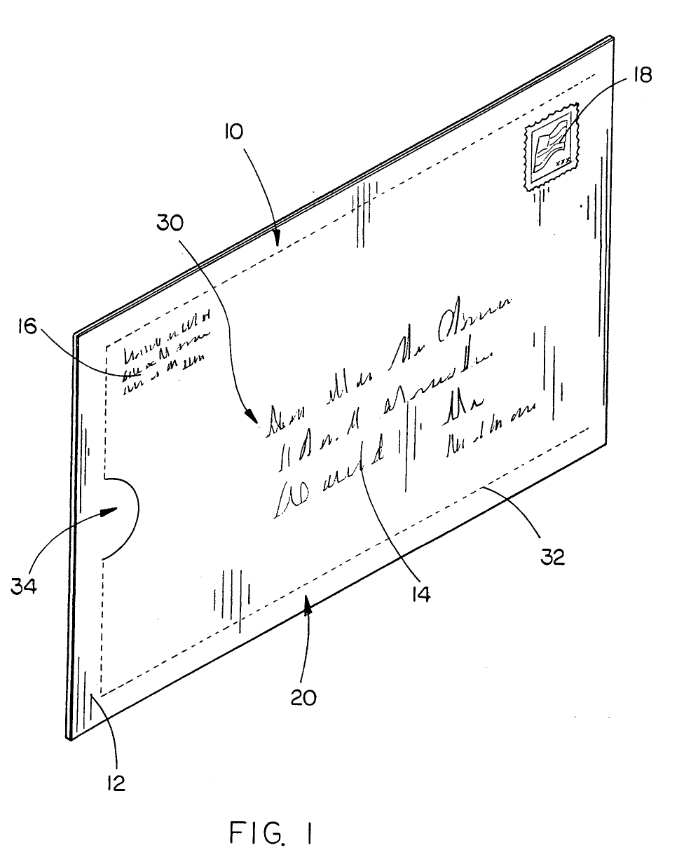

The post card message cover 10 of the present invention is shown best in FIGS. 1-3 as including a generally rectangular cover plate 12 which, in the preferred embodiment, would be formed of paper, plastic, or another such generally flexible and inexpensive material which is opaque in order to prevent viewing of the message contents prior to opening of the cover plate 12. The cover plate 12 would preferably have dimensions approximately equal to the size of the post card 50 on which it is to be mounted in order to completely cover the message side 52 of the post card 50. Of course, it is not critical that the cover plate 12 cover the entire message side 52 of post card 50 so long as the cover plate 12 is capable of covering the written message 54 on the message side 52 of post card 50 and preventing unauthorized reading thereof. It is further preferred that cover plate 12 also include sections adapted for printing of the destination address 14, the return address 16, and postage 18, all of which would be printed on the front side 20 of cover plate 12 as shown best in FIG. 1, although such printing is not necessary to the functionality of the present invention.

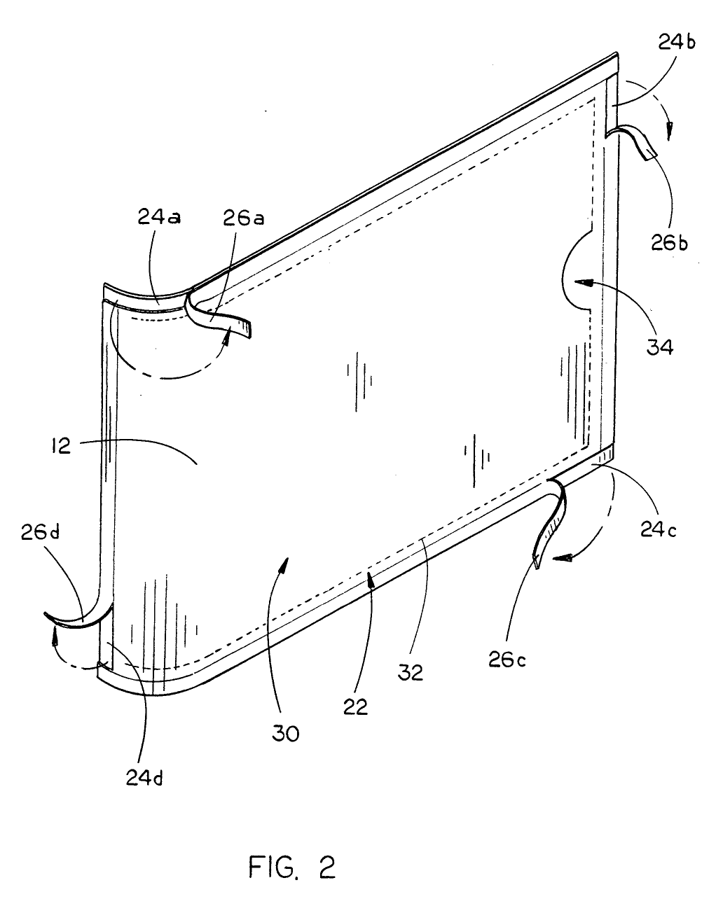

The rear side 22 of cover plate 12 is best shown in FIG. 2 as including a plurality of adhesive strips 24a, 24b, 24c, and 24d which are mounted to the rear side 22 on the periphery thereof. The adhesive strips 24a-d would preferably be constructed of an adhesive tape or glue substance and are covered with protective strips 26a, 26b, 26c, and 26d which cover the adhesive strips 24a-d prior to the cover plate 12 being affixed to the post card 50, thus preventing the adhesive strips 24a-d from affixing to materials prior to installation. Of course, the adhesive strips 24a-d may be of any acceptable size and shape so long as the adhesive function of the strips are maintained, and in fact, in another preferred embodiment, the adhesive strips 24a-d would be a single continuous strip running along the periphery of the cover plate 12. The protective strips 26a-d would then be replaced with a single, unitary protective strip or sheet covering the unitary adhesive strip which would be removable with a single peeling/removing motion, thus saving time and effort in the preparatory stages prior to application of the cover plate 12 to the post card 50.

Cover plate 12 further includes a message revealing panel section 30 which is formed by a series of perforations 32 which extend through the cover plate 12 as shown best in FIGS. 1 and 2. It is preferred that the perforations 32 extend in a generally continuous, generally rectangular form as shown best in FIG. 2, with a thumb slot 34 formed in the series of perforations 32 to facilitate the separation of the message revealing panel section 30 from the remainder of cover plate 12 along perforations 32. The perforations 32 are formed in any appropriate manner, such as by scoring, cutting or crimping the cover plate 12 via a mechanical device such as those presently used in the art.

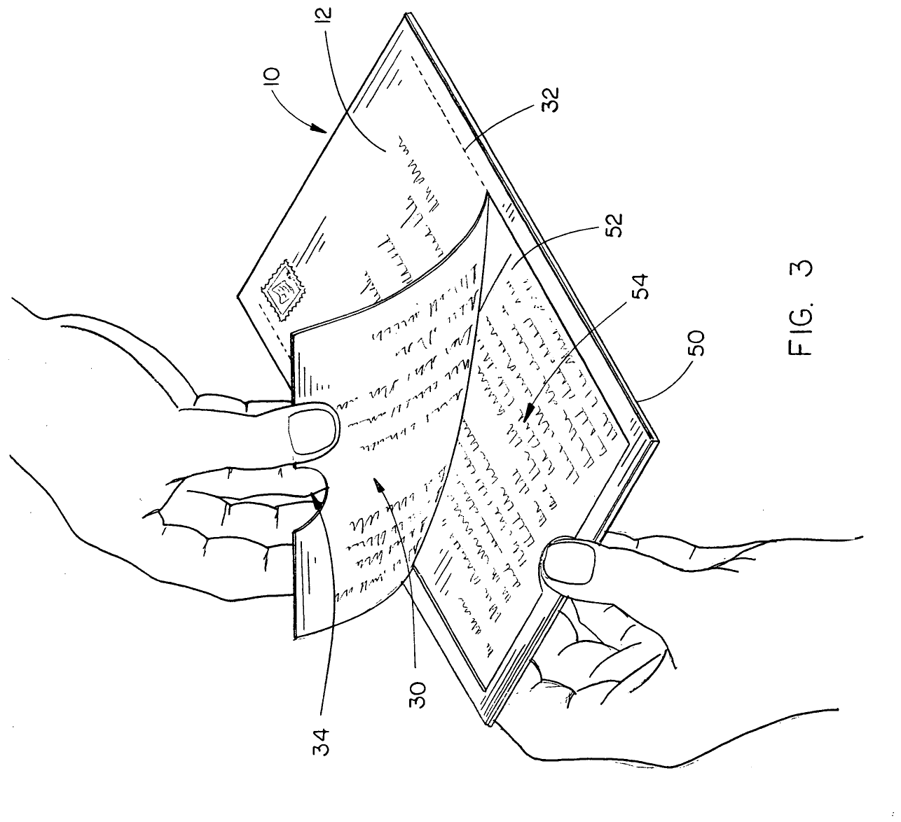

The post card message cover 10 of the present invention would be used in the following manner. The sender of the post card 50 would write message 54 on post card 50 on the message side 52 thereof. The post card message cover 10 would then be applied to the post card 50 by removing the protective strips 26a-d from adhesive strips 24a-d, thus revealing the adhesive tape material on the rear side 22 of cover plate 12. The cover plate 12 would then be affixed to the post card 50 as shown best in FIG. 3 such that the written message 54 is covered by cover plate 12 and the adhesive strips 24a-d secure the cover plate 12 to the message side 52 of post card 50 in generally parallel alignment therewith. The sender would then include the destination address 14, return address 16, and postage 18 on the front side 20 of cover plate 12 and send the post card 50 as would be done with an ordinary, unsecured post card.

Upon receiving the post card 50, the recipient of the post card would grasp the post card/cover plate combination with their thumb placed adjacent thumb slot 34. By bending the cover plate 12 and post card 50, several of the perforations 32 adjacent thumb slot 34 would be opened and the recipient of the post card 50 would then grasp the message revealing panel section 30 and separate the section 30 from cover plate 12 along the perforations 32 while the remainder of the cover plate 12 remains affixed to the post card 50. In this manner the written message 54 of the post card 50 would be revealed.

It is to be understood that numerous modifications, substitutions, and additions may be made to the post card message cover 10 of the present invention which fall within the intended broad scope of the preceding disclosure. For example, the size, shape and construction materials used in connection with the present invention may be modified and/or changed so long as the operative characteristics of the invention are neither degraded nor destroyed. Furthermore, the exact size and shape of the message revealing panel section 30 is not critical to the invention so long as the written message on the post card is revealed when the panel section 30 is removed. Finally, although the present invention has been described for use with post cards, the present invention may be used in any situation where a degree of security or confidentiality is desired with an exposed message-bearing surface.

There has therefore been shown and described a method and apparatus for securely and discretely sending and receiving messages on post cards which accomplishes at least all of its intended objectives.

I claim:

1. An apparatus for discretely and securely sending and receiving messages on post cards comprising:
a generally flat planar post card message cover having a rear side and a front side and being sized to fit onto and cover at least a portion of one side of a post card and the message written thereon;
at least one adhesive means mounted on said rear side of said post card message cover for securely attaching said post card message cover to a post card in generally parallel contact therewith with said rear side of said post card message cover adjacent the post card;
said post card message cover further including a generally opaque message revealing panel section positioned on said post card message cover, said message revealing panel section operative to removably cover a message printed on the post card, said message revealing panel section being movable between a message covering position releasably connected and aligned generally coplanar with said post card message cover and a message revealing position permitting viewing of a message printed on the post card.

2. The apparatus for discretely and securely sending and receiving messages on post cards of claim 1 wherein said adhesive means comprises at least one adhesive strip mounted on said rear side of said post card message cover adjacent an outer edge thereof for securing said post card message cover on a post card.

3. The apparatus for discretely and securely sending and receiving messages on post cards of claim 2 wherein said adhesive means comprises a plurality of adhesive strips mounted to said rear side of said post card message cover on the periphery thereof, and a plurality of protective strips mounted on and operative to generally cover said plurality of adhesive strips prior to the affixing of said post card message cover to a post card thereby preventing said plurality of adhesive strips from affixing to extraneous materials prior to being affixed to a post card.

4. The apparatus for discretely and securely sending and receiving messages on post cards of claim 1 wherein said message revealing panel section on said post card message cover is formed thereon by a series of spaced perforations formed in said post card message cover which extend therethrough such that said message revealing panel section is separable from said post card message cover along at least a portion thereof while the remainder of said post card message cover remains affixed to the post card, thereby revealing a written message on the post card.

5. The apparatus for discretely and securely sending and receiving messages on post cards of claim 4 wherein said series of perforations extend in a generally continuous, generally rectangular form further including a thumb slot formed in said series of perforations operative to facilitate the separation of said message revealing panel section from said post card message cover along said series of perforations.

6. A method of sending and receiving a post card with a message comprising the steps:
providing a post card with a message printed thereon;
providing a generally flat planar post card message cover having an rear side and a front side and including a generally rectangular generally opaque cover plate sized to fit onto and cover at least a portion of one side of said post card and the message written thereon;
providing at least one adhesive means mounted on said rear side of said post card message cover;
providing a generally opaque message revealing panel section positioned on said post card message cover, said message revealing panel section operative to removably cover a message printed on the post card, said message revealing panel section being movable between a message covering position releasably connected and aligned generally coplanar with said post card message cover and a message revealing position permitting viewing of a message printed on the post card;
covering said message on said post card with said post card message cover;
attaching said post card message cover to said post card via said at least one adhesive means with said rear side of said post card message cover adjacent and in generally parallel contact with said post card;
sending said attached post card message cover and said post card to a recipient;
receiving said attached post card message cover and said post card; and
moving said message revealing panel section of said post card message cover from said message covering position to said message revealing position thereby permitting viewing of said message printed on said post card.

7. The method of claim 6 further comprising the step of providing a series of perforations surrounding said message revealing panel section to facilitate at least partial separation of said message revealing panel section from said post card message cover.

8. The method of claim 7 further comprising after receiving said attached post card message cover and said post card, the step of separating said message revealing panel section from said post card message cover along said series of perforations while the remainder of said post card message cover remains adjacent said post card.
